(19) United States
(12) Patent Application Publication
(10) Pub. No.: US 2026/0131701 A1
(43) Pub. Date: May 14, 2026

(54) METHOD AND MOBILITY APPARATUS FOR SIMULTANEOUS BATTERY CHARGING

(71) Applicants: Hyundai Motor Company, Seoul (KR); Kia Corporation, Seoul (KR)

(72) Inventors: Byung Woo JEON, Hwaseong-Si (KR); Tae Seon YANG, Hwaseong-Si (KR)

(21) Appl. No.: 19/206,497

(22) Filed: May 13, 2025

(30) Foreign Application Priority Data
Nov. 14, 2024 (KR) 10-2024-0162177

(51) Int. Cl. B60L 58/40; B60L 50/75; B60L 53/54; H01M 8/04082; H01M 8/0438

(52) U.S. Cl. CPC B60L 58/40; B60L 50/75; B60L 53/54; H01M 8/04201; H01M 8/0438

(57) ABSTRACT

A method performed by an apparatus of a vehicle may comprise determining, based on driving conditions of the vehicle, whether a state condition for a simultaneous charging operation is satisfied. Based on the state condition for the simultaneous charging operation being satisfied, the method includes performing the simultaneous charging operation by controlling a fuel supply to a first fuel tank of the vehicle and a simultaneous charging of a battery of the vehicle. At least a portion of fuel from a second fuel tank of the vehicle is used to generate power for the charging of the battery based on a pressure in the second fuel tank exceeding a pressure threshold. The first fuel tank is operatively decoupled from at least one component of the vehicle during the simultaneous charging operation.

### CROSS-REFERENCE TO RELATED APPLICATION

The present application claims the benefit of priority to Korean provisional Patent Application No 10-2024-0162177, filed in the Korean Intellectual Property Office on Nov. 14, 2024, the entire contents of which are incorporated herein by this reference for all purposes.

### TECHNICAL FIELD

The present disclosure relates to a method and mobility apparatus for simultaneous battery charging, and more specifically, to a method and mobility apparatus for simultaneous battery charging that charge a battery while charging fuel.

### BACKGROUND

The matters described in this Background section are only for enhancement of understanding of the background of the disclosure, and should not be taken as acknowledgment that they correspond to prior art already known to those skilled in the art. In line with demanding eco-friendly energy sources for vehicles, vehicles are being designed to run on electric energy rather than fossil fuels. Electric vehicles may be provided in various ways depending on the type of energy source. For example, depending on the type of energy source, electric vehicles may use only a high-voltage battery that outputs driving power by external charging, or may utilize a fuel cell that is installed together with a high-voltage battery and charges the battery.

For example, a fuel cell may generate electricity using hydrogen fuel to charge a battery. In the case of a vehicle that uses hydrogen fuel, it may take about 10 to 20 minutes to charge the vehicle's battery. During charging a hydrogen vehicle, types of operations (e.g., power generation using the fuel cell and vehicle driving, etc.) of the hydrogen vehicle, which may affect the amount of hydrogen may be stopped or blocked for safety. For hydrogen vehicles, safely managing hydrogen may be a top priority.

For driving convenience, when charging hydrogen fuel while the battery's Soc (State of Charge) is low, there may be a technical limitation that a drivable distance perceived by a driver decreases compared to the amount of hydrogen injected due to the amount of hydrogen that could not be detected at the time of charging when driving begins after the hydrogen charging is completed. This may result in a limitation that reduces the overall charging efficiency.

Therefore, in terms of improving product competitiveness such as driver convenience and increasing the drivable distance with a single hydrogen fuel injection, it is desirable to have a full charging logic that checks the SoC of the battery simultaneously with hydrogen charging and controls the SoC of the battery to a target charging amount value through stack power generation.

### SUMMARY

An object of the present disclosure is to provide a method and mobility apparatus for simultaneous battery charging that charge a battery while charging fuel.

The technical problems solved by the present disclosure are not limited to the above technical problems and other technical problems which are not described herein will be clearly understood by a person (hereinafter referred to as an ordinary technician) having ordinary skill in the technical field, to which the present disclosure belongs, from the following description.

According to the present disclosure, a method performed by an apparatus of a vehicle, the method may comprise, determining, based on driving conditions of the vehicle, whether a state condition for a simultaneous charging operation is satisfied, and based on the state condition for the simultaneous charging operation being satisfied, performing the simultaneous charging operation by controlling a fuel supply to a first fuel tank of the vehicle and a simultaneous charging of a battery of the vehicle, wherein at least a portion of fuel from a second fuel tank of the vehicle is used to generate power for the charging of the battery based on a pressure in the second fuel tank exceeding a pressure threshold, and wherein the first fuel tank is operatively decoupled from at least one component of the vehicle during the simultaneous charging operation.

The method, may further comprise determining, based on the driving conditions, whether to, perform a fuel charging operation without simultaneous charging the battery when the driving conditions are satisfied, or identify the state condition for the simultaneous charging operation when at least one of the driving conditions is unsatisfied.

The method, wherein the driving conditions comprise at least one of, a target charge amount of the fuel to be supplied to the first fuel tank, a minimum amount of the at least the portion of the fuel from the second fuel tank for the simultaneous charging operation, route setting information, or a type of fuel charging station.

The method, may further comprise, performing a fuel charging operation when the state condition for the simultaneous charging operation is not satisfied, and requesting a response to select a charging method when the state condition for the simultaneous charging operation is satisfied.

The method, wherein the state condition may comprise at least one of, a pressure and temperature of the first fuel tank and the second fuel tank, a stack state of a fuel cell of the vehicle, a power generation capacity of the fuel cell, a state of the battery, or a state of a relay, wherein the relay corresponds to an electrical switch configured to control charging and discharging paths of the battery.

The method, wherein the controlling of the simultaneous charging of the battery may comprise, based on a determination that at least one of the state condition or a user state condition is not satisfied, switching to a fuel charging operation and stopping charging the battery.

The method, wherein a value of the pressure threshold is differently set for each of a plurality of fuel tanks may comprise the first fuel tank and the second fuel tank.

The method, wherein the controlling of the simultaneous charging of the battery may comprise, injecting fuel into the first fuel tank, wherein the first fuel tank is operatively decoupled from the at least one component of the vehicle by a changed state of a first connector, where the at least one component of the vehicle may comprise a fuel supplier configured to supply fuel to a fuel cell of the vehicle, delivering fuel to the second fuel tank using a second connector between the first fuel tank and the second fuel tank based on a pressure of the first fuel tank exceeding a first upper limit threshold, and changing a state of the second connector to decouple the second fuel tank from the first fuel tank and charging the battery using a third connector between the fuel supplier and the second fuel tank based on the pressure of the second fuel tank exceeding the pressure threshold.

The method, may further comprise, after the charging of the battery, changing a state of the third connector to decouple the second fuel tank from the fuel supplier based on a charge amount of the battery reaching a target charge amount or the pressure of the second fuel tank no longer exceeding the pressure threshold.

The method, may further comprise, requesting a response to select a charging operation, and based on a determination that the response has not been received within a predetermined time, selecting a default charging operation set by a user.

According to the present disclosure, an apparatus of a vehicle, the apparatus may comprise, a battery configured to supply power to the vehicle, a power generation cell configured to charge the battery, a processor, and a memory storing at least one instruction that, when executed by the processor communicating with the memory, is configured to cause the apparatus to, determine, based on driving conditions of the vehicle, whether a state for a simultaneous charging operation is satisfied, and based on the state condition for the simultaneous charging operation being satisfied, perform the simultaneous charging operation by controlling a fuel supply to a first fuel tank of the vehicle and a simultaneous charging of the battery, wherein at least a portion of fuel from a second fuel tank of the vehicle is supplied to the power generation cell to charge the battery based on a pressure in the second fuel tank exceeding a pressure threshold, and wherein the first fuel tank is operatively decoupled from at least one component of the vehicle during the simultaneous charging operation.

The apparatus, wherein the at least one instruction, when executed by the processor communicating with the memory, is configured to cause the apparatus to, perform a fuel charging operation based on the driving conditions being satisfied, and identify the state condition for the simultaneous charging operation based on at least one of the driving conditions is unsatisfied.

The apparatus, wherein the driving conditions comprise at least one of, a target charge amount of the fuel to be supplied to the first fuel tank, a minimum amount of the at least the portion of the fuel from the second fuel tank for the simultaneous charging operation, route setting information, or a type of fuel charging station.

The apparatus, wherein the at least one instruction, when executed by the processor communicating with the memory, is configured to cause the apparatus to, perform a fuel charging operation based on the state condition for the simultaneous charging operation not being satisfied, and request a response to select a charging method based on the state condition for the simultaneous charging operation being satisfied.

The apparatus, wherein the state condition may comprise at least one of, a pressure and temperature of the first fuel tank and the second fuel tank, a stack state of the power generation cell, a power generation capacity of the power generation cell, a state of the battery, or a state of a relay, wherein the relay corresponds to an electrical switch configured to control charging and discharging paths of the battery.

The apparatus, wherein the at least one instruction, when executed by the processor communicating with the memory, is configured to cause the apparatus to, based on a determination that at least one of the state condition or a user state condition is not satisfied, switch from the simultaneous charging operation to a fuel charging operation and stop charging the battery.

The apparatus, wherein a value of the pressure threshold is differently set for each of a plurality of fuel tanks may comprise the first fuel tank and the second fuel tank.

The apparatus, wherein the at least one instruction, when executed by the processor communicating with the memory, is configured to cause the apparatus to, inject fuel into the first fuel tank, wherein the first fuel tank is operatively decoupled from the at least one component of the vehicle by a changed state of a first connector, wherein the at least one component of the vehicle may comprise a fuel supplier configured to supply fuel to the power generation cell, deliver fuel to the second fuel tank using a second connector between the first fuel tank and the second fuel tank based on a pressure of the first fuel tank exceeding a first upper limit threshold, and change a state of the second connector to decouple the second fuel tank from the first fuel tank and charge the battery using a third connector between the fuel supplier and the second fuel tank based on the pressure of the second fuel tank exceeding the pressure threshold.

The apparatus, wherein the at least one instruction, when executed by the processor communicating with the memory, is configured to cause the apparatus to change a state of the third connector to decouple the second fuel tank from the fuel supplier based on a charge amount of the battery reaching a target charge amount or the pressure of the second fuel tank no longer exceeding the pressure threshold.

According to the present disclosure, a method performed by an apparatus of a vehicle, the method may comprise, supplying fuel to a first fuel tank of the vehicle while the first fuel tank is operatively decoupled from a fuel cell of the vehicle, transferring at least a portion of the fuel from the first fuel tank to a second fuel tank of the vehicle based on a pressure of the first fuel tank exceeding a first pressure threshold, operatively coupling the second fuel tank to the fuel cell based on a pressure of the second fuel tank exceeding a second pressure threshold, and charging a battery of the vehicle using power generated by the fuel cell, wherein the fuel cell is supplied with at least a portion of fuel from the second fuel tank while fuel is being supplied to the first fuel tank.

The effects obtainable from the present disclosure are not limited to the above-mentioned effects, and other effects not mentioned herein will be clearly understood by those skilled in the art through the following descriptions.

### BRIEF DESCRIPTION OF THE DRAWINGS

The above and other objects, features and other advantages of the present invention will be more clearly understood from the following detailed description taken in conjunction with the accompanying drawings, in which:

FIG. 1 shows an example of a mobility apparatus communicating with another apparatus to transmit and receive data;

FIG. 2 shows an example of a module constituting a mobility apparatus according to an example of the present disclosure;

FIG. 3 shows an example of a module included in a mobility system and a charging system according to an example of the present disclosure;

FIG. 4 shows an example of a method for simultaneous battery charging according to an example of the present disclosure;

FIG. 5 shows an example of a process for determining a charging method based on driving conditions;

FIG. 6 shows an example of a process for determining a charging method based on state information;

FIG. 7 shows an example of a simultaneous charging process;

FIG. 8 shows an example of a simultaneous charging process according to the present disclosure; and

FIG. 9 shows an example of processing of a processing module during simultaneous charging according to the present disclosure.

### DETAILED DESCRIPTION

Herein after, examples of the present disclosure are described in detail with reference to the accompanying drawings so that those having ordinary skill in the art may easily implement the present disclosure. However, examples of the present disclosure may be implemented in various different ways and thus the present disclosure is not limited to the examples described therein.

In describing examples of the present disclosure, well-known functions or constructions have not been described in detail since a detailed description thereof may have unnecessarily obscured the gist of the present disclosure. The same constituent elements in the drawings are denoted by the same reference numerals and a repeated or duplicative description of the same elements has been omitted.

In the present disclosure, when an element is simply referred to as being “connected to”, “coupled to” or “linked to” another element, this may mean that an element is “directly connected to”, “directly coupled to”, or “directly linked to” another element or this may mean that an element is connected to, coupled to, or linked to another element with another element intervening therebetween. In addition, when an element “includes” or “has” another element, this means that one element may further include another element

Without excluding another component unless specifically stated otherwise.

In the present disclosure, the terms first, second, etc. are only used to distinguish one element from another and do not limit the order or the degree of importance between the elements unless specifically stated otherwise. Accordingly, a first element in an example may be termed a second element in another example, and, similarly, a second element in an example could be termed a first element in another example, without departing from the scope of the present disclosure.

In the present disclosure, elements are distinguished from each other for clearly describing each feature, but this does not necessarily mean that the elements are separated. In other words, a plurality of elements may be integrated in one hardware or software unit, or one element may be distributed and formed in a plurality of hardware or software units. Therefore, even if not mentioned otherwise, such integrated or distributed examples are included in the scope of the present disclosure.

In the present disclosure, elements described in various examples do not necessarily mean essential elements, and some of them may be optional elements. Therefore, an example composed of a subset of elements described in an example is also included in the scope of the present disclosure. In addition, examples including other elements in addition to the elements described in the various examples are also included in the scope of the present disclosure.

The advantages and features of the present disclosure and the ways of attaining them should become apparent to those of ordinary skill in the art with reference to examples of the present disclosure described below in detail in conjunction with the accompanying drawings. The examples of the present disclosure, however, may be embodied in many different forms and should not be constructed as being limited to the example examples set forth herein. Rather, the examples described herein are provided to make this disclosure more complete and to fully convey the scope of the present disclosure to those having ordinary skill in the art to which the present disclosure pertains.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

In the present disclosure, expressions of location relations used in the present specification such as “upper”, “lower”, “left” and “right” are employed for the convenience of explanation, and when drawings shown in the present specification are inversed, the location relations described in the specification may be inversely understood. When a component, device, element, or the like of the present disclosure is described as having a purpose or performing an operation, function, or the like, the component, device, or element should be considered herein as being “configured to” meet that purpose or perform that operation or function.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

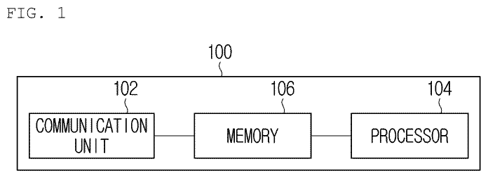

Hereinafter, with reference to FIGS. 1 to 3, a mobility apparatus implementing a method for simultaneous battery charging that charges a battery while charging fuel according to an example of the present disclosure will be described. FIG. 1 is a diagram illustrating a mobility apparatus communicating with another apparatus to transmit and receive data.

Referring to FIG. 1, the mobility apparatus 100 may be driven based on electric energy. For example, the mobility apparatus 100 (e.g., ground vehicles, flying vehicles, or waterborne vehicles, etc.) may employ a high-voltage battery as an energy source and a power generation cell that charges the high-voltage battery as an energy source. If the power generation cell is a fuel cell, the mobility apparatus 100 may charge the high-voltage battery by the power generation of the fuel cell and perform various functions e.g., door locking/unlocking, vehicle starting/shutdown, or battery charging management, etc.) required by the modules of the mobility apparatus 100 with the output power of the high-voltage battery. In addition, the fuel cell may use various forms of gas that may generate electric energy, for example, hydrogen. However, the present disclosure is not limited thereto, and various gases may be applied. For example, in addition to hydrogen, other various gases may include methanol, ethanol, methane (natural gas), ammonia, and hydrocarbons such as propane or butane. Some systems may also utilize formic acid or biogas (a mixture of methane and carbon dioxide). Depending on the fuel cell type—such as PEMFC, SOFC, or MCFC—these gases may require internal or external reforming to extract hydrogen or other usable components for power generation. In the present disclosure, an electric energy mobility apparatus is described as a fuel cell-based mobility apparatus 100 as an example. However, the present disclosure may be applied to a mobility apparatus in which the high-voltage battery and the power generation cell are of different types, and the power generation cell generates electricity and charges the high-voltage battery for outputting power for starting, driving, and accessories of the mobility apparatus 100.

The mobility apparatus 100 may refer to a movable subject (e.g., ground vehicles, flying vehicles, or waterborne vehicles, etc.). The mobility apparatus 100 is a vehicle, which is a ground mobility device that runs on the ground, and may be a typical passenger or commercial mobility apparatus, a mobile office, or a mobile hotel. The mobility apparatus 100 may be a four-wheeled mobility apparatus, such as a passenger car, an SUV, or a small truck, and may be a mobility apparatus with more than four wheels, such as a bus, a large truck, a container transport mobility apparatus, a heavy equipment mobility apparatus, etc. The mobility apparatus 100 may be a manned or unmanned robot using multiple batteries, and may be, for example, a robot apparatus for construction machinery, etc.

In addition, the mobility apparatus 100 is not limited to a ground mobility apparatus, and may be, for example, a battery-powered flying mobility apparatus or a waterborne mobility apparatus for water transportation. The flying mobility apparatus includes a manned or unmanned flying vehicle, and the unmanned flying vehicle may be, for example, a drone, a PAV (Personal Aerial Vehicle), or UAM (Urban Air Mobility). The waterborne mobility apparatus may be a manned or unmanned ship or submarine.

The mobility apparatus 100 may be implemented by a manual operation or an autonomous operation (e.g., manual driving, a semi-autonomous operation, or a fully autonomous operation).

The mobility apparatus 100 may perform communication with other devices or other mobility apparatus under the control of a communication control unit (CCU) mounted thereon. The other devices may include, for example, a server 200 that supports various controls, state management, and driving of the mobility apparatus 100, an ITS device for receiving information from an Intelligent Transportation System (ITS), various types of user devices 300 (e.g., smartphones, tablets, wearable devices, or laptops, etc.), etc.

The mobility apparatus 100 may communicate with other mobility apparatus or other devices based on cellular communication (e.g., LTE, LTE-A, 5G, or 6G, etc.), WAVE (Wireless Access in Vehicular Environment) communication, DSRC (Dedicated Short Range Communication) or short-range communication (e.g., Bluetooth, Bluetooth Low Energy (BLE), infrared, or Near Field Communication (NFC), etc.), or other communication methods.

For example, the mobility apparatus 100 may use a cellular communication network (e.g., LTE, LTE-A, 5G, or 6G, etc.), a WiFi communication network (e.g., Wi-Fi 5, Wi-Fi 6, or Wi-Fi 6E, etc.), or a WAVE communication network for communication with the server 200 and other mobility apparatuses. The mobility apparatus 100 may receive a request from the user device 300 via the server 200 by the above-described communication, and transmit a response to the request to the user device 300. Here, the user device 300 may be various types of electronic devices (e.g., smartphones, tablets, smartwatches, or laptops, etc.). In addition, a DSRC, etc. used in the mobility apparatus 100 may be used for communication between mobility apparatuses (e.g., vehicle-to-vehicle (V2V), vehicle-to-infrastructure (V2I), or vehicle-to-pedestrian (V2P) communication, etc.). In addition, the mobility apparatus 100 may communicate with a key fob, which is a type of user device (e.g., smart keys, digital keys, or key cards, etc.) using short-range communication. The short-range communication may be, for example, Bluetooth, infrared communication, or NFC (Near Field Communication). The communication method between the mobility apparatus 100, the server 200, and the user device 300 is not limited to the above-described example.

The server 200 may transmit various information and software modules used to control the mobility apparatus 100 to the mobility apparatus 100 and the user device 300 in response to requests and data transmitted from the mobility apparatus 100 and the user device 300. In addition, the server 200 may be controlled to receive a remote control command for the mobility apparatus 100 from the user device 300 and to implement the corresponding function of the mobility apparatus 100, for remote control of a specific function requested by a user (e.g., remote start, climate control activation, or battery management, etc.). In relation to the present disclosure, the server 200 may transmit various information, software modules, or applications required for simultaneous battery charging of the mobility apparatus 100.

The user device 300 may have an application embedded therein for processing control, state management, etc. of the mobility apparatus 100. The user may remotely request specific control processing from the mobility apparatus 100 using the application. The control-related processing may be, for example, ignition reservation, ignition start/shutdown, door opening/closing, air conditioning reservation/on/off/setting, cooling/heating control of components of the mobility apparatus 100 for the convenience of boarding and driving, and battery charging port opening/closing. The state-related processing may be, for example, a battery charging state, a drivable distance, a location of the mobility apparatus 100, and states of various components of the mobility apparatus 100 (e.g., door open/close state, cooling/heating states, air conditioning settings, or interior temperature, etc.). The processing request described as an example is transmitted to the server 200, and the server 200 transmits a command according to the processing request to the mobility apparatus 100, and the server 200 may receive a processing result for the request from the mobility apparatus 100 and provide it to the application. In addition, the user device 300 may additionally be equipped with separate software that provides a simple control processing function (e.g., unlocking doors, remote start, or charging port control, etc.) to an authenticated user through direct short-range communication with the mobility apparatus 100 when approaching the mobility apparatus 100 within a predetermined distance range. The user device 300 may directly communicate with the mobility apparatus 100 through the separate software without going through the server 200, and provide the user with a simple function (e.g., door locking/unlocking, vehicle starting/shutdown, or battery charging management, etc.) among the above-described control processing functions of the application. The simple function is at least some of the above-described control processing functions, and may be, for example, starting/shutdown, opening/closing a door, opening/closing a battery charging port, etc.

Hereinafter, for convenience of explanation, examples according to the present disclosure will be described on the assumption that the mobility apparatus 100 is a vehicle operating on the ground. However, examples of the present disclosure may be applied to various types of the above-described mobility apparatus (e.g., ground vehicles, flying vehicles, or waterborne vehicles, etc.).

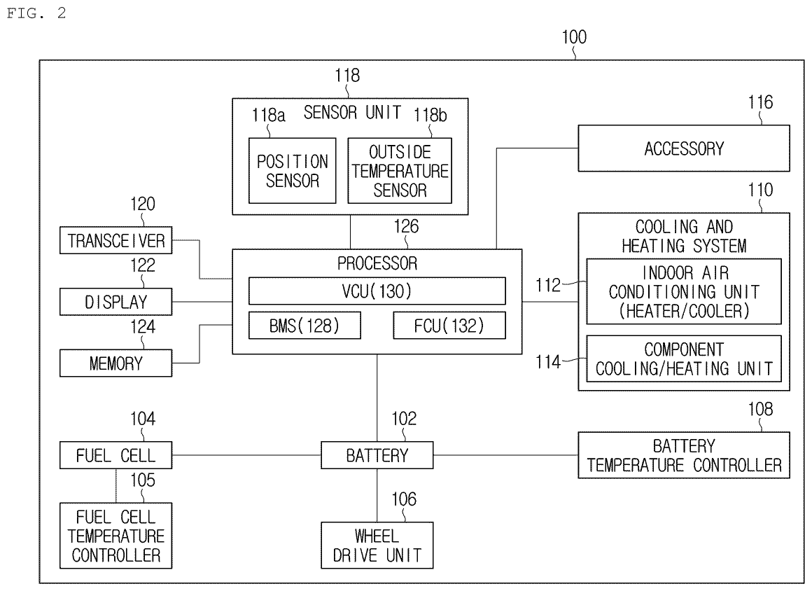

FIG. 2 is a diagram illustrating a module constituting a mobility apparatus according to an example of the present disclosure.

The mobility apparatus 100 may include a battery 102, a power generation cell 104, a wheel drive unit 106, a battery temperature controller 108, and a power generation cell temperature controller 105. In the present disclosure, the power generation cell may be a fuel cell, for convenience of explanation. The power generation cell and the power generation cell temperature controller may be referred to as a fuel cell and a fuel cell temperature controller, and these terms may be used interchangeably.

The battery 102 may be charged by the power generation of the fuel cell 104 and supply power required for the modules of the mobility apparatus 100. The battery 102 may be a high-voltage battery composed of secondary batteries (e.g., lithium-ion, nickel-metal hydride, solid-state, lithium-polymer, or lead-acid batteries, etc.). The battery 102 may supply energy for, for example, starting, driving, and operating load devices 110 and 116 of the mobility apparatus 100. Specifically, the battery 102 may provide energy applied from the fuel cell 104 to the starting, driving, air conditioning, component cooling/heating modules, and various electric devices (e.g., infotainment systems, lighting systems, sensors, or vehicle electronics, etc.) of the mobility apparatus 100. The battery 102 may output a higher voltage than the fuel cell 104 and supply energy to, for example, a wheel drive unit 106 and a high-power electric module (e.g., high-power motors, electric compressors, or electric heaters, etc.).

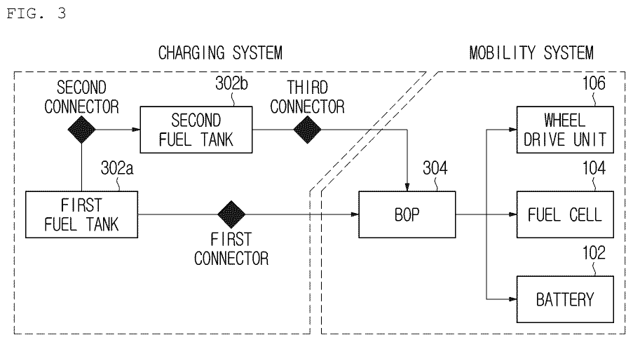

The fuel cell 104 may include a hydrogen fuel cell that generates electric energy through a reaction between hydrogen supplied from a fuel tank (not shown) and oxygen supplied from the outside. Specifically, the fuel cell 104 may be controlled to an optimal state by a Balance of Plant (BOP). For example, the BOP may include, but is not limited to, a hydrogen supply system, an air supply system, a humidification system, a water management system, an exhaust system, a heat management system for managing the heat of the stack of the fuel cell 104, and a hydrogen recirculation pump for managing excess hydrogen. The BOP will be described in more detail with reference to FIG. 3. In addition, the fuel cell 104 may generate power by an amount of power determined based on power required for starting, driving, and the load devices 110 and 116, and may charge the battery 102 with the generated power. In addition, the fuel cell 104 may supply energy to a low-power electric module (e.g., infotainment system, sensors, or interior lighting modules, etc.) mounted on the mobility apparatus 100 according to design specifications. The fuel cell 104 may be composed of multiple stacks (e.g., two stacks, three stacks, or more, etc.), for example, and may generate electricity for each stack.

Although not shown, a converter is a module that functions as an up/down converter, converting a voltage from the fuel cell 104 and supplying it to the battery 102, thereby charging the battery 102. Depending on the operating situation, the converter may supply power with the converted voltage to the wheel drive unit 106 and various electronic devices (e.g., electric motors, power steering modules, or electric braking systems, etc.) that operate in a high voltage range. The electronic devices may be, for example, an accessory 114 (e.g., electric air compressors, heaters, or battery management circuitry, etc.).

The wheel drive unit 106 may be a module that receives power from the battery 102 and drives the wheel. The wheel drive unit 106 may include a motor unit and a wheel unit. For example, all of the wheel units may be connected to the motor unit and driven (e.g., an all-wheel drive electric system, etc.). As another example, only some of the wheel units may be connected to the motor unit, and the wheel units that are not connected to the motor unit may be driven by the wheel unit driven by the motor (e.g., front-wheel or rear-wheel drive electric systems, etc.). The wheel unit may include a wheel and a wheel brake module (e.g., disc brakes, drum brakes, or regenerative braking modules, etc.). The wheel brake module may be a module that transmits braking force to the wheel according to a deceleration control request from a driver or a processor 126 to decelerate the wheel.

The motor unit may receive power from the battery 102 and generate driving force. The motor unit transmits the driving force to the wheel unit, so that the wheel unit may be rotated. The motor unit may include, for example, a motor (e.g., AC induction motor, permanent magnet synchronous motor, brushless DC motor, or switched reluctance motor, etc.) that transmits the driving force to the wheel unit, and a motor control module (e.g., inverter or motor control circuit, etc.) that controls motor torque, motor rotation direction, braking, etc. The motor unit may be driven by receiving power supplied from the battery 102 and passing through an inverter (not shown). The inverter may convert a specific form of power of the battery 102, for example, alternating current (AC), into another form, for example, direct current (DC), and reduce the voltage. The inverter may also convert a specific form of reverse power of the motor unit caused by regenerative braking into a form suitable for the battery 102 and provide it to the battery 102.

A battery temperature controller 108 may heat or cool the battery 102 by controlling the temperature of the battery 102 to a desired temperature through coolant circulating through the battery 102 and direct heat transfer (e.g., using liquid coolant, air cooling systems, heat exchangers, or thermal pads, etc.). The battery temperature controller 108 may be equipped with a plurality of modules (e.g., cooling fans, pumps, chillers, heating circuitry, or valves, etc.) that control the temperature of the battery 102.

The mobility apparatus 100 may include the load devices 110 and 116, a sensor unit 118, a transceiver 120, a display 122, a memory 124 and the processor 126.

The load devices 110 and 116 may be auxiliary devices mounted on the mobility apparatus 100 and consume power supplied from the battery 102 by use by a passenger or user. The load devices 110 and 116 may be a type of non-driving electric device (e.g., interior/exterior lighting, infotainment system, navigation devices, USB charging ports, etc.) excluding a driving power system such as the wheel drive unit 106 in the present disclosure.

The cooling and heating system 110 may include an indoor air conditioning unit 112 and a component cooling/heating unit 114. The indoor air conditioning unit 112 may be equipped with a heater and a cooler (or air conditioner) for controlling the indoor temperature of the mobility apparatus 100 (e.g., cabin heating and cooling, windshield defrosting, etc.). Here, the indoor heating process by the heater may be simply referred to as a heating process for the convenience of description in the present disclosure.

The component cooling/heating unit 114 may be a device for cooling/heating a component for the convenience of boarding and driving (e.g., heated steering wheel, heated seats, cooled seats, heated side mirrors, or heated windshield, etc.). Specifically, the component cooling/heating unit 114 may be controlled to heat or cool a component of the mobility apparatus that comes into contact with a user or removes a driving obstacle. The component cooling/heating unit 114 may be, for example, a heat wire controller of a steering wheel, a heat wire controller of a seat, a heater for removing moisture from windows, side mirrors, etc.

The accessory 116 is an auxiliary device other than the cooling and heating system 110, and may be, for example, a lighting system, a seat system, and various devices (e.g., interior ambient lighting, power-adjustable seats, or automatic sunroofs, etc.) installed in the mobility apparatus 100.

The sensor unit 118 may include various types of sensor modules (e.g., position sensors (GPS), external temperature sensors, image sensors, lidar sensors, laser sensors, radar sensors, ultrasonic sensors, distance sensors, wheel speed sensors, gyro sensors, seat pressure sensors, door open/closed sensors, etc.) for detecting various states and situations occurring in the internal and external environments of the mobility apparatus 100. The sensor unit 118 may include, for example, a position sensor 118a and an outside temperature sensor 118b.

The position sensor 118a may measure the two-dimensional position and altitude of the mobility apparatus 100 during driving to detect the position of the mobility apparatus 100. The position sensor 118a may be, for example, a GPS sensor, and the GPS sensor may measure the position of the mobility apparatus 100 based on information transmitted from multiple satellites. The position sensor 118a is not limited to the GPS sensor, and may be composed of multiple sensors combined with other sensors including the GPS sensor. The outside temperature sensor 118b may measure the outside temperature at the current position of the mobility apparatus 100. Although not shown, the sensor unit 118 may include an indoor temperature sensor that measures the indoor temperature of the mobility apparatus 100. In addition, the sensor unit 118 may include an image sensor, a lidar sensor, a laser sensor, a distance sensor, a wheel speed sensor, a gyro sensor that detects the attitude and direction of the mobility apparatus 100, etc. In the present disclosure, only the sensors referred to in the description of the examples are described, and sensors that detect various situations not listed therein may be additionally included. For example, the sensor unit 118 may include a seat pressure sensor that detects the pressure of a seat used by a user of the mobility apparatus 100, and a sensor that detects the open/closed state of a door.

The transceiver 120 may support intercommunication with the server 200, a neighboring mobility apparatus 100, a roadside base station, or the user device 300 (e.g., using LTE, 5G, WiFi, DSRC, Bluetooth, or NFC communications, etc.).

In the present disclosure, the transceiver 120 may transmit data generated or stored during driving to the server 200 under the control of a communication control unit (CTU), and receive data and software modules transmitted from the server 200. In the present disclosure, the mobility apparatus 100 may transmit and receive data utilized in the method according to the present disclosure to and from the outside through the transceiver 120. For example, decision data on a default charging method of a fuel, which is normal charging or simultaneous charging, set by the user of the mobility apparatus 100 in advance, may be transmitted to the server 200.

The display 122 may function as a user interface (e.g., touchscreen, instrument cluster, head-up display (HUD), or voice interface, etc.). The display 122 may display, by the processor 126, the operation state, the control state, the route/traffic information, the battery state, the gas remaining information, the content requested by the driver, etc. of the mobility apparatus 100. The display 122 is configured as a touchscreen capable of detecting the driver's input and may receive the driver's request instructing the processor 126 (e.g., driver input for selecting charging methods, responding to alarms, adjusting system settings, or viewing status information, etc.). In the present disclosure, the display 122 may provide a pop-up window or a setting window to select an alarm or a charging method in order to request a user's response to the charging method (e.g., choosing between normal charging, simultaneous charging, or confirming safety-related notifications, etc.). In addition, in the present disclosure, the display 122 may provide an appropriate response alarm for each situation (e.g., visual warning messages, audible alarms, or urgent safety alerts, etc.) to prevent an emergency accident caused by battery charging at the same time as fuel injection (e.g., “Keep door open during simultaneous charging,” or “Check fuel tank pressure,” etc.).

The memory 124 stores an application and various data for controlling the mobility apparatus 100, and may load the application or read and write data at the request of the processor 126. In the present disclosure, the memory 124 may store an application and at least one instruction for determining whether to enter normal charging or examine state information (e.g., route length, fueling station type, target fuel amount, or current system state, etc.) for simultaneous charging based on a driving condition, entering normal charging or requesting a response to a charging method based on whether the state information is normal, and responding to a request to perform simultaneous charging, separating the mobility system and the charging system to charge fuel, but incorporating a part of the charging systems into the mobility system depending on whether the pressure exceeds a threshold to simultaneously charge the battery 102.

To this end, the memory 124 may store and manage, for example, state information of the mobility apparatus 100 used to determine the order of detailed operations related to simultaneous battery charging (e.g., tank pressure, battery SoC, relay states, fuel cell stack states, or temperature limits, etc.), user state information (e.g., user's seat occupancy, door/window status, user location, or safety-related behavior, etc.), and default charging methods (e.g., user-selected default preference such as normal charging or simultaneous charging, etc.).

Specifically, the memory 124 may store data related to the pressure and temperature of the fuel tank, the stack state of the fuel cell 104 (e.g., current voltage, output current, temperature, or operational diagnostics, etc.), the power generation capacity of the fuel cell 104 (e.g., maximum and actual power output, system efficiency, or stack health information, etc.), the state of the battery 102 (e.g., battery charge percentage (SoC), cell voltages, battery temperature, battery health indicators, or charge limits, etc.), and the relay state (e.g., relay connectivity status, functional condition, or operational safety, etc.), etc., in relation to the state information of the mobility apparatus 100. In addition, the memory 124 may store data related to seat pressure information, door open/close information (e.g., detected by seat occupancy sensors, door sensors, or cabin status sensors, etc.), etc., in relation to the user state information. In addition, the memory 124 may store decision data according to the charging method set by the user in advance (e.g., default charging preferences, simultaneous charging enabled/disabled states, or user-configured thresholds, etc.) in relation to the default charging method.

The memory 124 may manage detailed requests according to automatic settings, regardless of user requests, such as pressure thresholds and temperature thresholds of the fuel tank (e.g., upper/lower pressure limits, temperature safety limits, or error-margin adjustments, etc.), basic charging mode (e.g., default normal or simultaneous charging, etc.), and driving conditions for simultaneous charging entry (e.g., minimum distance, fuel tank state thresholds, or battery state conditions, etc.).

The processor 126 may perform overall control of the mobility apparatus 100. The processor 126 may be configured to execute applications and instructions stored in the memory 124. In connection with the present disclosure, the processor 126 may determine, based on driving conditions (e.g., route selection, target fuel amount, fueling station capability, or user's preference, etc.), whether to enter normal charging or to examine state information for simultaneous charging using the applications, instructions, and data stored in the memory 124. In addition, the processor 126 may enter normal charging or request a response to a charging method based on whether the state information is normal (e.g., battery temperature within limits, sufficient fuel tank pressure, stable fuel cell operation, or safe user conditions, etc.). In addition, the processor 126 may charge fuel by separating the mobility system and the charging system in response to the request to perform simultaneous charging, and may simultaneously charge the battery 102 by incorporating a part of the charging system into the mobility system depending on whether the pressure exceeds the threshold (e.g., transferring fuel from a main tank to a sub-tank upon exceeding a certain pressure threshold, etc.). In one example, the above-described operation may be performed in at least a part of the processor 126, such as a part of at least one processing module and the memory 124.

As another example, the above-described operation may be performed in a plurality of processing modules and a memory built into each module, and the plurality of processing modules and the built-in memory may constitute the processor 126 and the memory 124 according to the present disclosure.

For example, the plurality of processing modules may be configured as individual processing modules controlling each member of the mobility apparatus 100 and an upper processing module managing the individual processing modules at an upper level. Specifically, the individual processing modules controlling and managing the battery 102 may be a battery management system (BMS) 128, a fuel cell control unit (FCU) 132 controlling and managing the fuel cell 104, a hydrogen management unit (HMU) managing the supply and blocking of hydrogen to and from the fuel cell 104, and a fuel cell DC-DC converter (FDC) managing the voltage and current of the power generated by the fuel cell 104. Although not shown, the individual processing modules controlling the transceiver 120 to perform data communication may be a communication control unit (CTU).

The upper processing module that manages all of the above-described individual processing modules may be a vehicle control unit (VCU) 130. When entering normal charging or simultaneous charging, the HMU may transmit data or signals for the charging state of the battery 102 e.g., battery charging status, battery health information, or current SoC values, etc.), the remaining amount of fuel in the fuel tank (e.g., State of Fuel (SoF)), the pressure of the fuel tank (e.g., current tank pressure, safety limits, or system diagnostics, etc.), and signals for waking up the VCU 130 to the VCU 130. Accordingly, the BMS 128 may transmit and receive information about the SoC of the battery 102 to and from the VCU 130, and may transmit and receive information about the charging limit, current, and voltage of the battery 102, for example. In addition, the FCU 132 may transmit information about the power generation capacity, power generation demand, and actual power generation capacity of the fuel cell 104 to the VCU 130. In addition, the FDC may transmit and receive state information of the power generated by the fuel cell 104 (e.g., high-side voltage/current, low-side voltage/current, or DC-DC converter operational state, etc.) to and from the VCU 130. Through this, the VCU 130 may examine state information for simultaneous charging of the mobility apparatus 100 using the above-described information and determine whether to enter normal charging or simultaneous charging. In addition, the VCU 130 may determine whether to maintain simultaneous charging or re-enter normal charging using the above-described information.

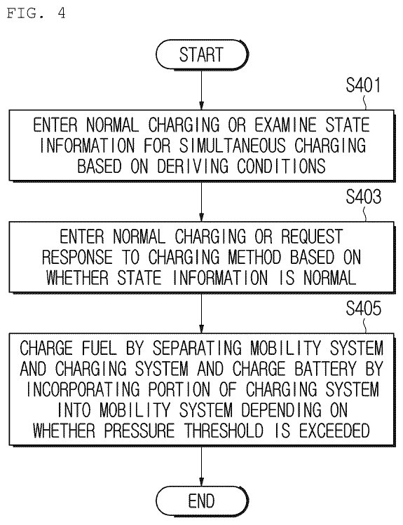

According to the above, the control of the logic for charging the battery simultaneously with fuel injection is performed through the exchanged data and processing in the BMS 128, the VCU 130, and the communication control unit (CTU). However, in the present disclosure, for the convenience of explanation, it is described that the processor 126 including these processing modules processes the control for charging the battery simultaneously with fuel injection. Even if the detailed process for the above-described processing is described as being performed by the processor 126, the processing module responsible for the detailed process may be clearly inferred from the above-described matter. Accordingly, in the present disclosure, the processor means a conceptual controller including a single or a plurality of processing modules. The processing of the processor 126 described above will be described in detail with reference to FIGS. 4 to 9.

Hereinafter, for convenience of understanding, a simultaneous battery charging method according to an example of the present disclosure will be described by dividing the modules of the mobility apparatus 100 into systems with reference to FIG. 3. Modules of the mobility apparatus 100 that do not require explanation in FIG. 3 are omitted, and it should be noted that they are not understood as unnecessary components for implementing the present disclosure.

FIG. 3 shows an example of a module included in a mobility system and a charging system according to an example of the present disclosure.

Referring to FIG. 3, the mobility apparatus 100 may be divided into a charging system and a mobility system. The charging system may include a component (e.g., fuel tanks, connectors, valves, pumps, regulators, or couplings, etc.) for injecting fuel into the mobility apparatus 100, a means for storing or delivering/blocking the injected fuel, etc. For example, the charging system may include a first fuel tank 302a and a second fuel tank 302b, and may further include a second connector connecting the first fuel tank 302a and the second fuel tank 302b. The processor 126 may control the second connector to deliver the fuel in the first fuel tank 302a to the second fuel tank 302b. For example, the first fuel tank 302a may mean a main tank into which fuel is directly injected from an external fuel injection device (e.g., a hydrogen fueling station, portable fuel supply unit, or refueling vehicle, etc.). The second fuel tank 302b may be understood as a sub-tank that is separated from the main tank, and configured to receive and temporarily store fuel (e.g., excess hydrogen fuel, compressed fuel, or reserve fuel, etc.).

Although FIG. 3 shows two fuel tanks, the present disclosure is not limited thereto, and three or more fuel tanks may be provided (e.g., additional intermediate tanks, emergency backup tanks, or auxiliary fuel storage tanks, etc.) unless it conflicts with the present disclosure. Similarly, although FIG. 3 shows three connectors, additional connectors may be provided (e.g., safety valves, emergency cut-off connectors, pressure-regulating connectors, or quick-release couplings, etc.) so that the charging system and the mobility system remain separated while allowing only a portion of the charging system to be incorporated into the mobility system.

In addition, the charging system may have a first connector and a third connector to deliver fuel to the mobility system to charge the battery 102. Specifically, the first fuel tank 302a and the second fuel tank 302b of the charging system may be connected to the mobility system through the first connector and the third connector to deliver fuel, for charging the battery 102. The processor 126 may independently operate the first connector through the third connector (e.g., activating, disconnecting, or adjusting flow rates, etc.) to charge the battery 102 while maintaining a separation state between the charging system and the mobility system. That is, although FIG. 3 shows that the first fuel tank 302a and the second fuel tank 302b are included in the charging system, this is not mandatory, and the tanks 302a and 302b may be incorporated into the mobility system depending on whether the first connector through the third connector is operated or disconnected. For example, if the second connector is disconnected but the third connector is operating, the second fuel tank 302b may be understood to be incorporated into the mobility system. For the ease understanding, assuming that the first connector and the third connector are disconnected, if fuel is injected into the first fuel tank 302a and delivered to the second fuel tank 302b (e.g., the second connector is operating), the first fuel tank 302a and the second fuel tank 302b may be understood as belonging to the charging system. On the other hand, if the second connector is disconnected and the third connector is operating for charging of the battery 102, the second fuel tank 302b is incorporated into the mobility system, separated from the charging system in which fuel is injected into the first fuel tank 302a, and thus the fuel in the second fuel tank 302b may be used for charging of the battery 102, separate from the fuel being injected.

Existing hydrogen vehicles are designed to have a structure in which hydrogen moves from a fuel tank to a fuel cell stack through a driving device (e.g., BOP), To prevent accidents such as explosions due to vehicle starting during fuel charging, the fuel tank and the fuel cell stack are configured to be disconnected during charging. Since the charging system and the mobility system according to the present disclosure are maintained in a separated state by independently operating components for delivering/blocking fuel for each of a plurality of fuel tanks (e.g., using connectors, valves, pumps, pressure regulators, or couplings, etc.), accidents (e.g., explosions or fires, etc.) caused by driving or battery power generation of the mobility apparatus 100 while fuel is being charged can be prevented, thereby enabling battery power generation even during charging.

As a means for delivering/blocking fuel, for example, the connector may employ a device that delivers or blocks fuel by controlling the flow rate (e.g., solenoid valves, pressure regulators, electric pumps, or flow-control valves, etc.). For example, the connector may employ a valve, a pressure regulator, a pump, etc. In addition, for example, the connector may employ a coupling device that connects the fuel supply line only when delivering fuel (e.g., quick-connect couplings, locking couplings, safety couplings, or pressure-sensitive couplings, etc.), thereby establishing a connection.

The mobility system may include components of the mobility apparatus 100 that utilize the charging or charged power of the battery 102. As an example, the mobility system may include the BOP 304, the battery 102, the fuel cell 104, and the wheel drive unit 106.

The BOP 304 may refer to a control module that controls power generation of the fuel cell 104 in a desirable or optimal state. Specifically, the BOP 304 may include auxiliary devices (e.g., fuel cell temperature controller 105, battery temperature controller 108, hydrogen supply systems, air supply systems, humidification systems, water management systems, exhaust systems, or hydrogen recirculation pumps, etc.) or systems except for the fuel cell 104, which is a main power generation device, and as an example, a fuel cell temperature controller 105 for managing the heat of the fuel cell 104 stack and the battery temperature controller 108 described in FIG. 2 may be included in the BOP 304. In addition, the BOP 304 may further include a hydrogen supply system that controls the supply of hydrogen to the stack of the fuel cell 104 by an amount required by the system, an air supply system that supplies oxygen to the fuel cell 104, a humidification system that controls the humidity of the fuel cell 104 stack to maintain an efficient reaction, a water management system and exhaust system for managing water discharged after the reaction, a hydrogen recirculation pump that manages surplus hydrogen (e.g., recirculating unused hydrogen back to the stack, releasing excess hydrogen safely, or adjusting hydrogen flow based on stack operation, etc.), etc. The processing of each of the above-described individual modules of the BOP 304 may be controlled by the VCU 130, and for convenience of description, is described as being performed by the processor 126. Even though the detailed process for the above-described processing is described as being performed by the processor 126, the processing module responsible for the detailed process may be clearly inferred from the above-described matter.

Referring to FIG. 4, a method of charging a battery simultaneously with charging fuel according to another example of the present disclosure will be described in detail. FIG. 4 is a flowchart of a method for simultaneous battery charging according to an example of the present disclosure.

Referring to FIG. 4, the processor 126 enters normal charging or examines state information for simultaneous charging based on driving conditions (S401). Specifically, the processor 126 examines the driving conditions, enters normal charging when the conditions are satisfied, and examines state information for simultaneous charging when at least one of the conditions is unsatisfied. Normal charging may mean a charging method that injects only fuel through a connection between an external fuel injection device (e.g., hydrogen fueling station, external tank, mobile fueling truck, or fueling station dispenser, etc.) and a fuel tank without simultaneously charging the battery 102. The simultaneous charging mentioned in the present disclosure may collectively refer to a process of simultaneously charging the fuel tank included in the charging system and charging the battery 102. In addition, simultaneous charging may be used interchangeably with a simultaneous charging process.

The driving condition may include conditions for minimizing the charging time or for determining the priority among the charging time and the driving distance after charging (e.g., prioritizing shorter fueling time over range or prioritizing longer driving range after charging, etc.). For example, the driving condition may be defined to prioritize minimizing the charging time (e.g., during short breaks or rapid refueling sessions, etc.), so that only normal charging is considered when the driving condition is satisfied. In addition, for example, the driving condition may be defined to prioritize the driving distance after charging (e.g., during long-distance travel, extended trips, or when the next refueling opportunity is uncertain, etc.), so that simultaneous charging is considered preferentially when the driving condition is satisfied. For example, the driving condition may be defined by factors such as information about a route set by a user (e.g., trip route length, availability of fueling stations, or traffic conditions, etc.), a type of an external fuel injection device (e.g., high-capacity station, low-capacity station, mobile refueling unit, etc.), a target charge amount of fuel (e.g., partial fill, full fill, or specific percentage fill, etc.), and a minimum amount of fuel for simultaneous charging (e.g., minimum pressure or minimum hydrogen amount threshold, etc.). In the following, for convenience of explanation, it is assumed that normal charging is considered preferentially when the driving condition is satisfied.

The state information for simultaneous charging may include additional factors considered for performing simultaneous charging prior to entering simultaneous charging. For example, the state information for simultaneous charging may include state information of components of the mobility apparatus required for charging the battery 102 (e.g., fuel tank pressure, battery SOC, fuel cell stack condition, relay state, system temperature, or sensor feedback, etc.). Specifically, the state information for simultaneous charging may include information on states of components included in the charging system or the mobility system for entering simultaneous charging. For example, the state information may include, but is not limited to, a pressure and temperature of the fuel tank, state and power generation capacity of the fuel cell 104 stack (e.g., stack voltage, current, or power output capability, etc.), state and SOC of the battery 102 (e.g., charge percentage, battery voltage, battery temperature, or battery health state, etc.), a main relay (e.g., open, closed, or partially engaged, etc.), and the like.

The processor 126 enters normal charging or requests a response to a charging method based on whether the state information is normal (S403). Specifically, the processor 126 requests a response for the charging method when the state information is normal, and may enter normal charging when at least one of the state information is abnormal. The process of requesting a response to the charging method may be implemented in a way that is expressed by a means that may be visually or audibly recognized by a user of the mobility apparatus 100, thereby causing a predetermined reaction from the user (e.g., responding via touchscreen, voice command, button press, or physical interaction, etc.). For example, the process of requesting the response to the charging method may be implemented as a process that is expressed by a detectable UI on the display 122 (e.g., pop-up menu, alert message, or selection button on a touchscreen, etc.) and requests an input from the user. As another example, the process of requesting the response to the charging method may be implemented by a process of outputting voice (e.g., audible alert or voice prompt via speakers, etc.) and requesting an input from the user. Also, as another example, the response to the charging method may be determined so as to be confirmed by the user's action (e.g., user interaction, gesture, presence detection, or vehicle door/window status, etc.). For example, the processor 126 may determine that a response to simultaneous charging has been received when it is determined that the user's state is safe (e.g., detecting that the user exited the vehicle, doors/windows are open, or no passenger seat pressure is detected, etc.). As another example, the processor 126 may determine that a response to simultaneous charging has been received when the user performs a preset action (e.g., user pressing a dedicated simultaneous charging button, using a smartphone app confirmation, or activating a remote key fob function, etc.). For example, the processor 126 may determine that a response to simultaneous charging has been received when the door or window of the mobility apparatus 100 is kept open, or when it is determined that the user is outside because no pressure is detected on the seat of the mobility apparatus 100.

The processor 126 charges fuel by separating the mobility system and the charging system, and charges the battery by incorporating a portion of the charging system into the mobility system depending on whether a pressure threshold is exceeded (S405). For convenience of understanding, the structure of the charging system described in FIG. 3 is used, but for convenience of explanation, it is assumed that two fuel tanks are provided. Specifically, the processor 126 maintains the first, second, and third connectors in a disconnected state so that fuel is injected into the first fuel tank separated from the mobility system. Next, when the pressure of the first fuel tank exceeds the pressure threshold as the fuel is injected, the processor 126 controls the second connector to deliver fuel to the second fuel tank.

The pressure threshold may be determined based on the design specifications of the fuel tank or the system settings (e.g., maximum operating pressure, safety margins, or regulatory standards, etc.). The pressure threshold may be determined to be a specific value (e.g., 350 bar, 700 bar, or other specified hydrogen tank pressures, etc.), and may be determined to be in a predetermined range in which a buffer is reflected to absorb errors and vibrations of sensed pressure (e.g., ±5 bar margin, etc.). The pressure threshold may be defined as an upper limit of the fuel tank pressure for safety, and may be differently set for each fuel tank. The upper limit pressure threshold may be understood as a criterion for delivering fuel to a fuel tank used for simultaneous charging of the battery 102 when the pressure of the fuel tank becomes higher than a predetermined value (e.g., exceeding 350 bar or 700 bar, etc.). In addition, the pressure threshold may include a lower limit of the fuel tank pressure for simultaneous charging (e.g., minimum pressure for safe operation or stable fuel delivery, etc.). The lower limit pressure threshold may be understood as a criterion for stopping the fuel delivery to the fuel tank for simultaneous charging of the battery 102 when the pressure of the fuel tank becomes lower than a predetermined value (e.g., below 100 bar, 200 bar, etc.).

As fuel is delivered to the second fuel tank through the second connector, if the pressure of the second fuel tank exceeds the pressure threshold, the processor 126 disconnects the second connector and controls the battery 102 to generate power with the fuel from the second fuel tank using the third connector (i.e., incorporating the second fuel tank into the mobility system for simultaneous charging).

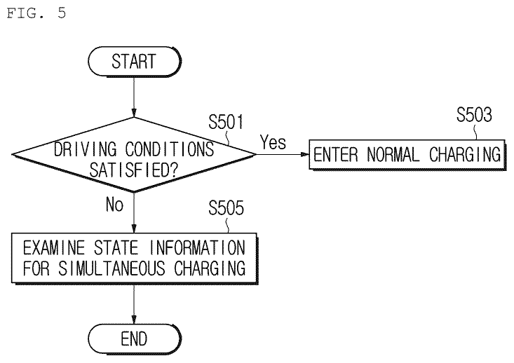

Hereinafter, the process of entering normal charging or examining state information for simultaneous charging based on driving conditions will be described in detail through FIG. 5. FIG. 5 shows an example of a process for determining a charging method based on driving conditions.

Referring to FIG. 5, the processor 126 determines whether the driving conditions are satisfied (S510). Specifically, the processor 126 injects fuel through the connection between the external fuel injection device (e.g., hydrogen fueling station, portable fueling device, or remote fuel dispenser, etc.) and the fuel tank or determines the charging method to enter by examining the driving conditions before injection. The driving conditions may be defined by factors such as information about a route set by the user (e.g., total distance, estimated driving time, traffic conditions, or road types, etc.), the type of the external fuel injection device (e.g., rapid charger, standard-speed charger, portable charger, or high-capacity fueling station, etc.), the target charge amount of the fuel (e.g., percentage fill, full-tank fill, partial fill, or specific hydrogen volume, etc.), and the minimum amount of fuel for simultaneous charging (e.g., threshold fuel quantity, minimum hydrogen pressure, or minimum tank level, etc.), but are not limited thereto.

For example, the processor 126 determines the charging method to enter by examining the target charge amount of the fuel and the minimum amount of fuel for simultaneous charging. For example, the processor 126 may compare the target charge amount of the fuel input by the user (e.g., through a user interface, voice command, or preset vehicle preference, etc.) and the minimum amount of fuel for simultaneous charging, and enter normal charging when the target charge amount is less than the minimum amount of fuel for simultaneous charging. That is, when the target charge amount of the fuel input by the user is less than the minimum amount of fuel for simultaneous charging, the processor 126 may preferentially consider normal charging by determining that the user will resume driving after a quick charging completion (e.g., short stops, rest area refueling, or urban commuting scenarios, etc.). In addition, the processor 126 determines the charging method to enter by examining the information about the route set by the user and the type of the external fuel injection device. For example, when the route option of a destination set by the user is set to minimize or reduce travel time (e.g., quickest route, shortest travel duration, or high-speed priority, etc.) and a rapid charging-only charger is used, the processor 126 may enter normal charging. For example, in the above-described situation, the processor 126 may preferentially consider normal charging by determining that the user prioritizes quick arriving at the destination (e.g., urgent travel, short-distance trip, or tightly scheduled appointments, etc.).

When the driving conditions are satisfied, the processor 126 enters normal charging (S503). For example, the processor 126 examines the driving conditions, and enters normal charging when the driving conditions are satisfied. As another example, the processor 126 may examine the driving conditions, and enter normal charging when any one of the driving conditions is satisfied (e.g., satisfying either quick charging preference or short-route requirement, etc.).

The processor 126 examines the state information for simultaneous charging when the driving conditions are unsatisfied (S505). For example, the processor 126 examines the state information for simultaneous charging if at least one of the driving conditions is unsatisfied (e.g., user selected longer range, sufficient fuel is available, or rapid charging conditions not met, etc.). As another example, the processor 126 may examine the state information for simultaneous charging when the driving conditions are unsatisfied (e.g., conditions for quick fueling, rapid charging, or minimal fueling time not met, etc.).

More specifically, the processor 126 examines state information of components included in the charging system or the mobility system to enter simultaneous charging. For example, the processor 126 examines the pressure and temperature of the fuel tank (e.g., fuel pressure sensor readings, tank temperature sensors, or valve status, etc.), the state and power generation capacity of the fuel cell 104 stack (e.g., stack voltage levels, current output, power stability, or system health diagnostics, etc.), the state and SOC of the battery 102 (e.g., battery state-of-charge percentage, cell voltage consistency, battery temperature, or maximum charging limits, etc.), the main relay (e.g., relay contact status, open or closed position, or functional integrity, etc.), etc. Specifically, the processor 126 examines whether the above-described components are normal. For example, the processor 126 checks the state of the fuel tank (e.g., internal pressure, internal temperature, valve conditions, or safety status, etc.) and examines whether they are within the normal range required by the design specification (e.g., acceptable pressure ranges, operational temperature limits, or functional valve settings, etc.). In addition, as an example, the processor 126 may examine whether the operating state and power generation capacity of the fuel cell 104 stack have an error (e.g., detecting stack failures, performance degradation, or insufficient power generation, etc.) or are within the normal range. In addition, as an example, the processor 126 checks the charging limit, SoC, cell temperature, etc. of the battery 102 and examines whether they are within the normal range required by the design specification (e.g., battery overheating prevention, safe state-of-charge limits, or thermal stability, etc.).

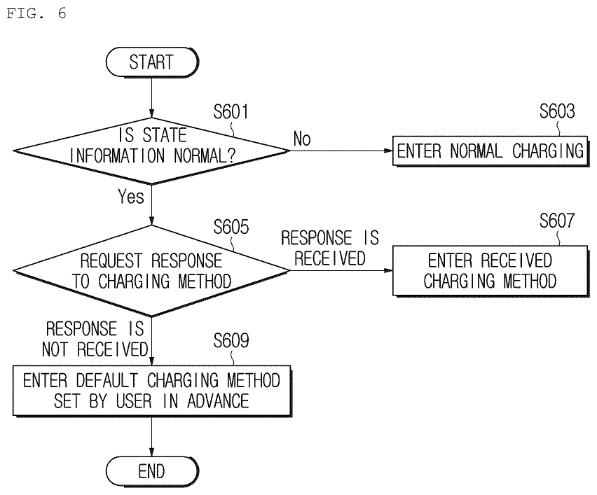

Next, the processor 126 may enter normal charging when at least one of the state information is abnormal (e.g., battery overheating, low fuel cell performance, or unsafe fuel tank pressure detected, etc.). That is, the processor 126 may enter simultaneous charging if the state information is normal. As another example, the processor 126 may enter normal charging if the state information is abnormal (e.g., multiple safety parameters simultaneously exceeded, multiple critical errors detected, or combined battery and fuel cell system malfunctions, etc.). The above-described processing will be described in detail with reference to FIG. 6.

FIG. 6 shows an example of a process for determining a charging method based on state information. Referring to FIG. 6, the processor 126 determines whether the state information is normal (S601). Specifically, the processor 126 examines the state information of components included in the charging system or the mobility system to enter simultaneous charging. For example, the processor 126 examines the states of the fuel tank (e.g., tank pressure, internal temperature, valve condition, or sensor integrity, etc.) and the battery 102 (e.g., state-of-charge (SOC), battery temperature, charge limit, cell voltage, or battery health, etc.), the state and power generation capacity of the fuel cell 104 stack (e.g., stack voltage, current output capability, operational efficiency, or system errors, etc.), and the main relay (e.g., relay connectivity, switching condition, or functional status, etc.).

The processor 126 enters normal charging when at least one item of the state information is abnormal (S603). In the present disclosure, the description focuses on entering normal charging when at least one of the state information is abnormal, but is not limited thereto, and the conditions for entering normal charging may be set differently depending on whether the state information is normal. For example, the processor 126 may enter normal charging when the state information is abnormal (e.g., multiple critical failures, simultaneous sensor malfunctions, or combined battery and fuel cell issues, etc.).

The processor 126 requests a response to the charging method when the state information is normal (S605). Specifically, the processor 126 may receive the response to the charging method through a predetermined reaction of the user using a means that the user may visually or audibly recognize (e.g., via a display notification, audible alerts, voice prompts, or user interface controls, etc.). For example, the processor 126 may request the response to the charging method by providing a detectable pop-up window or setting window through the display 122 (e.g., touchscreen alert, dialog box, or menu option, etc.). For example, the processor 126 may provide a UI that allows the user to select either normal charging or simultaneous charging (e.g., selectable buttons, checkboxes, or slider controls, etc.). In addition, as an example, the processor 126 may control a speaker to provide a voice alarm for allowing the user to select either normal charging or simultaneous charging (e.g., voice instructions, audible warnings, or voice recognition interface prompts, etc.). In addition, as an example, the processor 126 may determine the charging method based on the user's behavior without requesting a separate response from the user. For example, the processor 126 may determine that a response to simultaneous charging has been received when the user's state is determined to be safe using a sensor provided in the mobility apparatus 100 (e.g., seat occupancy sensor, door/window sensors, interior cabin sensors, or proximity detection sensors, etc.).

When the response to the charging method is received, the processor 126 enters the received charging method (S607). Specifically, when a response to normal charging is received (e.g., via explicit user selection, UI confirmation, or voice command, etc.), the processor 126 may enter normal charging. On the other hand, when a request for a simultaneous charging is received (e.g., confirmed by user interaction, interface selection, or a recognized safe state, etc.), the processor 126 may enter simultaneous charging.

When the response to the charging method is not received, the processor 126 enters a default charging method set by the user in advance (S609). For example, the user may be located outside the mobility apparatus 100 during the process of charging fuel, or may be unable to input the response to the charging method due to another action (e.g., refueling activity, using a fueling station interface, or being temporarily away from the vehicle, etc.). When the response to the charging method is not received, as in the example described above, the processor 126 enters the default charging method and may wait for a predetermined period of time as a condition for entering the default charging method (e.g., waiting 30 seconds, 1 minute, or another preset interval, etc.). For example, when the response to the charging method is not received for a predetermined period of time, the processor 126 enters the default charging method.

The default charging method may be set by the user in advance or determined to be a default value according to the system settings (e.g., system factory default or user-customized default, etc.). For example, the user may set a desired charging method among normal charging or simultaneous charging as the default charging method by manipulating the instrument panel at a desired time (e.g., via vehicle infotainment system, mobile app, or settings menu, etc.). The default charging method may be stored in the NVM (Non-Volatile Memory) area of the VCU 130 and may be stored semi-permanently so as not to be changed even if the system is repeatedly turned on or off due to power cutoff or supply (e.g., memory retained through power cycles, battery disconnect, or system resets, etc.). For example, when the user sets simultaneous charging as the default charging method, the processor 126 enters simultaneous charging if no response to the charging method is received for a predetermined time (e.g., no user response within 30 seconds or 1 minute, etc.). On the other hand, if the user sets normal charging as the default charging method, the processor 126 enters normal charging if no response to the charging method is received for a predetermined time (e.g., user absence or no response within specified waiting time, etc.).

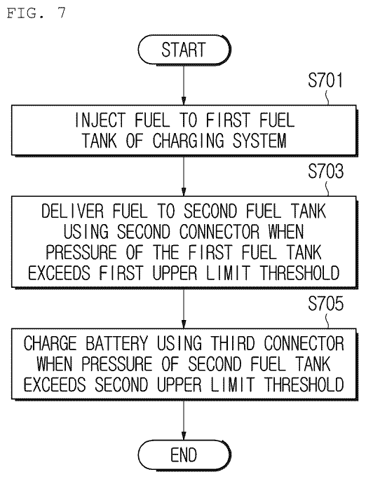

Next, a process of simultaneously charging the battery 102 according to the present disclosure will be described in detail with reference to FIG. 7. FIG. 7 shows an example of a simultaneous charging process.

Referring to FIG. 7, the processor 126 controls fuel to be injected into the first fuel tank of the charging system during simultaneous charging (S701). Hereinafter, for convenience of understanding, the structure described in FIG. 3 will be used for description, but unless it conflicts with the present disclosure, the charging system may have an additional fuel tank or connector (e.g., third fuel tank, intermediate storage tanks, additional connectors, or safety valves, etc.). In addition, the first fuel tank and the second fuel tank may be referred to as a main tank or a sub-tank, respectively, and may be used interchangeably in the present disclosure. Referring to FIG. 3, the processor 126 controls fuel to be directly injected into the first fuel tank, but disconnects the first connector, the second connector, and the third connector to separate the charging system and the mobility system.

The processor 126 delivers fuel to the second fuel tank using the second connector when the pressure of the first fuel tank exceeds a first upper limit threshold (S703). Specifically, the processor 126 operates only the second connector when the pressure of the first fuel tank exceeds the first upper limit threshold during the process of injecting fuel so that the fuel in the first fuel tank is delivered to the second fuel tank, while maintaining the state in which the charging system and the mobility system are separated. At this time, as the fuel stored in the first fuel tank is moved to the second fuel tank, the fuel reduced in the first fuel tank is replenished from an external fuel injection device (e.g., hydrogen refueling station, portable hydrogen storage, or fuel dispenser, etc.).

The first upper limit threshold may be determined based on the design specifications of the first fuel tank or system settings as the upper pressure threshold of the first fuel tank (e.g., maximum allowable pressure limits, recommended safe operating pressures, or regulatory guidelines, etc.). The first upper limit threshold may be determined to be a specific value, and may also be determined to be in a predetermined range in which a buffer is reflected to absorb errors and vibrations of sensed pressure (e.g., ±50 bar buffer, sensor error margins, or vibration compensations, etc.). The first upper limit threshold may be defined as the upper limit of the pressure of the first fuel tank for safety. That is, the first upper limit threshold may be understood as a criterion for delivering fuel to the second fuel tank used for simultaneous charging of the battery 102 when the pressure of the first fuel tank equal to or greater than a predetermined value (e.g., when tank pressure exceeds 2000 bar, 1800 bar, or a designed operational threshold, etc.). For example, when the appropriate pressure range of the first fuel tank is 1000 bar to 2361 bar, the first upper limit threshold may be set to 2000 bar. The first upper limit threshold may be set within a limit that does not exceed the design specifications of the first fuel tank, and may be changed according to the system settings (e.g., adjusted via software updates, user settings, or factory presets, etc.).

The processor 126 continuously measures the pressure of the first fuel tank (e.g., via tank pressure sensors, monitoring systems, or embedded diagnostics, etc.), and controls fuel delivery to the second fuel tank when the pressure of the first fuel tank exceeds the first upper limit threshold, thereby controlling the pressure of the first fuel tank within the pressure threshold.

The processor 126 may control the pressure of the first fuel tank not to fall below a first lower limit threshold. The first lower limit threshold may be understood as a criterion for stopping the fuel delivery to the second fuel tank for simultaneously charging the battery 102 when the pressure of the first fuel tank falls below a predetermined value (e.g., when tank pressure reaches 1300 bar, 1200 bar, or another defined safety margin, etc.). For example, the processor 126 may control the fuel delivery to the second fuel tank to be stopped (e.g., to prevent pressure from dropping too low and ensure tank stability, etc.) when the pressure of the first fuel tank falls below the first lower limit threshold while fuel is delivered to the second fuel tank as the pressure of the first fuel tank exceeds the first upper limit threshold. For example, when the appropriate pressure range of the first fuel tank is 1000 bar to 2361 bar, the first lower limit threshold may be set to 1300 bar. The first lower limit threshold may be set within a limit that does not exceed the design specification of the first fuel tank and may be changed according to system settings (e.g., adjusted through software calibration or safety regulations, etc.).

The processor 126 charges the battery 102 using the third connector when the pressure of the second fuel tank exceeds a second upper limit threshold (S705). Specifically, the processor 126 disconnects the second connector when the pressure of the second fuel tank exceeds the second upper limit threshold, and charges the battery 102 using the third connector connecting the mobility system and the second fuel tank. That is, in the process of charging the battery 102 while injecting fuel, the second connector is disconnected and the third connector is operated, so that the charging system in which fuel is being injected into the first fuel tank is separated from the mobility system. As a result, since only the second fuel tank is incorporated into the mobility system, the fuel in the second fuel tank may be used to charge the battery 102 separately from the fuel being injected. Accordingly, the first fuel tank belongs to the charging system and the second fuel tank belongs to the mobility system, so that the charging system (including the first fuel tank connected to the external fuel injection device) and the mobility system involved in charging the battery 102 remain separated, enabling safe fuel charging and simultaneous power generation.

The second upper limit threshold is the upper-limit pressure threshold of the second fuel tank and may be determined based on the design specifications or system settings of the second fuel tank (e.g., structural limits, recommended operational pressures, or safety regulations, etc.). The second upper limit threshold may be determined to be a specific value, and may be determined to be in a predetermined range in which a buffer is reflected to absorb errors and vibrations of sensed pressure (e.g., ±30 bar margin, etc.). The second upper limit threshold may be defined as the upper limit of the pressure of the second fuel tank for safety. That is, the second upper limit threshold may be understood as a reference value at which simultaneous charging of the battery 102 is initiated when the pressure of the first fuel tank becomes equal to or greater than a predetermined value (e.g., when second tank pressure exceeds 1800 bar, etc.). For example, when the appropriate pressure range of the second fuel tank is from approximately 1000 bar to 2361 bar, the second upper limit threshold may be set to 1800 bar. The second upper limit threshold may be set within a limit that does not exceed the design specifications of the second fuel tank, and may be changed according to the system settings. In addition, the second upper limit threshold may be set to be smaller than the first upper limit threshold of the first fuel tank (e.g., second tank at 1800 bar vs. first tank at 2000 bar, ensuring safe sequential operations, etc.).

The processor 126 continuously measures the pressure of the second fuel tank, and controls the delivery of fuel to the BOP when the pressure of the second fuel tank exceeds the second upper limit threshold, thereby controlling the pressure of the second fuel tank within the pressure threshold.

The processor 126 may control the pressure of the second fuel tank not to fall below the second lower limit threshold. The second lower limit threshold may be understood as a criterion for stopping simultaneous charging of the battery 102 when the pressure of the first fuel tank falls below a predetermined value (e.g., below 1400 bar, 1300 bar, or another safe operating threshold, etc.). For example, the processor 126 may control the fuel delivery to the BOP to stop (e.g., to prevent under-pressure conditions, excessive fuel usage, or safety risks, etc.) when the pressure of the second fuel tank falls below the second lower limit threshold, even when the pressure of the second fuel tank exceeds the second upper limit threshold and fuel is delivered to the BOP. For example, when the appropriate pressure range of the second fuel tank is 1000 bar to 2361 bar, the second lower limit threshold may be set to 1400 bar. The second lower limit threshold may be set within a limit that does not exceed the design specifications of the second fuel tank, and may be changed according to system settings. In addition, the second lower limit threshold may be set to be smaller than the first lower limit threshold of the first fuel tank (e.g., second tank lower limit at 1200 bar vs. first tank lower limit at 1300 bar, etc.). If the third connector is disconnected and charging of the battery 102 is stopped because the pressure of the second fuel tank is less than the second lower limit threshold, the processor 126 repeats the steps after S703 (e.g., restarting fuel transfer operations, reconnecting connectors, or reinitiating pressure management, etc.).

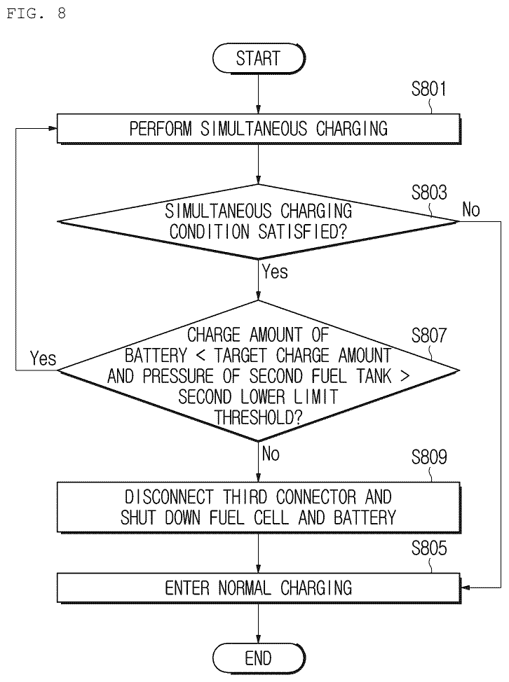

FIG. 8 shows an example of a simultaneous charging process according to the present disclosure. Referring to FIG. 8, the processor 126 performs simultaneous charging (S801). Specifically, the processor 126 simultaneously charges the battery 102 while fuel is injected in a substantially the same manner as described in FIG. 7.

The processor 126 determines whether simultaneous charging conditions are satisfied (S803). Specifically, the processor 126 continuously monitors whether the simultaneous charging condition is satisfied while the battery 102 is being simultaneously charged. The simultaneous charging condition may include state information of components of the mobility apparatus required for charging the battery 102 and user state information. For example, state information of components of the mobility apparatus required for charging the battery 102 may include the pressure and temperature of components (e.g., the fuel tank pressure, fuel tank temperature) belonging to the charging system, valve states, the stack state of the fuel cell 104, the power generation capacity of the fuel cell 104, the state and SoC of the battery 102, the relay state, or sensor diagnostic data, etc. The user state information may include information on the state of the mobility apparatus 100 caused by the user or conditions indicating user presence or behavior. For example, the user state information may include, but is not limited to, the user's location (e.g., inside or outside the vehicle, proximity detected via key fob, or smartphone location tracking, etc.), behavioral state (e.g., seated, standing outside, door status, window open/closed status, seatbelt status, or detected movement patterns, etc.), etc. In addition, for example, the user state information may include, but is not limited to, pressure information detected on a seat mounted on the mobility apparatus 100 (e.g., seat occupancy sensors or passenger presence detection, etc.) and information on a door signal (e.g., door open/close sensors or door latch status sensors, etc.).

The processor 126 enters normal charging when the simultaneous charging conditions are unsatisfied (S805). Specifically, the processor 126 may enter normal charging when at least one of the simultaneous charging conditions is determined to be abnormal (e.g., exceeded temperature limits, low pressure in fuel tank, relay malfunction, battery overheating, user in unsafe state, or doors/windows closed during simultaneous charging, etc.). For example, the processor 126 may determine that the state of the component of the mobility apparatus required for charging the battery 102 as abnormal if values associated with the state are outside the appropriate range required by the design specifications or the system setting range.

For example, during the simultaneous charging process, as at least one of the simultaneous charging conditions, for example, if the pressure of the first fuel tank becomes less than the lower pressure threshold (e.g., below 1300 bar or another preset lower limit, etc.), the processor 126 stops the simultaneous charging process and enters normal charging. Also, for example, when the temperature of the first fuel tank exceeds the design specification (e.g., exceeds 85° C. or another temperature safety limit, etc.), the processor 126 stops the simultaneous charging process and enters normal charging. With respect to the pressure of the first fuel tank, when the pressure of the first fuel tank exceeds the lower pressure threshold as the normal charging progresses, the processor 126 may re-examine whether the simultaneous charging condition is satisfied.

The processor 126 determines whether the charge amount of the battery 102 is less than or equal to a target charge amount and whether the pressure of the second fuel tank is greater than the second lower limit threshold (S807). Specifically, the processor 126 determines, assuming that the above-described simultaneous charging conditions are satisfied/fulfilled, whether the current actual charge amount (e.g., actual battery SoC measurement amount, battery voltage, or capacity percentage, etc.) of the battery 102 has reached the target charge amount (e.g., preset SoC target value for simultaneous charging termination such as 80%, 90%, or user-defined limits, etc.) of the battery 102 for terminating simultaneous charging during the simultaneous charging process. For example, the processor 126 continuously performs simultaneous charging when the actual charge amount of the battery 102 does not reach the target charge amount by the simultaneous charging according to the present disclosure. Specifically, the processor 126 operates the stack of the fuel cells 104 using fuel from the second fuel tank to which the BOP is connected, and charges the battery 102 using the generated power so that the actual charge amount of the battery 102 reaches the target charge amount.

In addition, the processor 126 determines whether the pressure of the second fuel tank is equal to or greater than the second lower limit threshold (e.g., 1400 bar, 1300 bar, or a system-defined pressure threshold, etc.), assuming that the above-described simultaneous charging conditions are satisfied/fulfilled. For example, the processor 126 continuously performs simultaneous charging when the pressure of the second fuel tank is equal to or greater than the second lower limit threshold. Specifically, the processor 126 operates the stack of the fuel cell 104 using the fuel of the second fuel tank to which the BOP is connected, and charges the battery 102 using the generated power so that the actual charge amount of the battery 102 reaches the target charge amount. The processor 126 continuously monitors whether the simultaneous charging conditions of step S803 are satisfied and the charge amount of the battery 102 and the pressure of the second fuel tank of step S807 to determine whether to continue simultaneous charging or to terminate simultaneous charging and enter normal charging. The processor 126 may stop simultaneous charging when the pressure of the second fuel tank is less than the second lower limit threshold or when the charge amount of the battery 102 reaches the target charge amount, as detailed below.

When the charge amount of the battery 102 reaches or exceeds the target charge amount, or when the pressure of the second fuel tank becomes less than the second lower limit threshold, the processor 126 disconnects the third connector and shuts down the fuel cell 104 and the battery 102 (S809). Specifically, if the charge amount of the battery 102 reaches the target charge amount or the pressure of the second fuel tank becomes less than the second lower limit threshold while the simultaneous charge conditions are satisfied, the processor 126 disconnects the third connector to stop delivering of the fuel from the second fuel tank to the BOP.

For example, if the charge amount of the battery 102 is less than the target charge amount or the pressure of the second fuel tank is less than the second lower limit threshold, the processor 126 stops the power generation of the stack of the fuel cell 104 and disconnects the third connector to separate the second fuel tank from the mobility system. In addition, the processor 126 shuts down the battery 102 to block charging of power according to the power generation of the fuel cell 104. The processor 126 disconnects the third connector, and after the fuel cell and battery are shut down, reconnects the second connector to receive fuel from the first fuel tank so that the pressure of the second fuel tank may be restored. Thereafter, when the pressure of the second fuel tank exceeds the second upper limit threshold (e.g., 1800 bar or another preset threshold, etc.), the processor 126 may perform simultaneous charging again so that the charge amount of the battery 102 reaches the target charge amount.

Additionally, as an example, the processor 126 stops power generation of the stack of the fuel cell 104 and disconnects the third connector to separate the second fuel tank from the mobility system, when the pressure of the second fuel tank is below the second lower limit threshold or the charge amount of the battery 102 reaches the target charge amount. In addition, the processor 126 shuts down the battery 102 to prevent overcharging from power generation of the fuel cell 104.

The processor 126 may provide a warning alarm for the safety of the user during the simultaneous charging according to the present disclosure. For example, the processor 126 may check the pressure of the seat and the open/closed state of the door to provide a warning alarm to the user using visual or auditory means (e.g., alerts via instrument cluster, display 122, or audible warnings through speakers, etc.). For example, the processor 126 may check the seat pressure sensor and door information (e.g., sensors detecting door state or seat occupancy) to provide an alarm through the cluster or the display 122 when the user is seated in the seat and the door is closed. For example, the processor 126 may provide a phrase such as “Please keep the door open for quick evacuation in case of an emergency” as a warning alarm, thereby ensuring additional safety against emergency accidents that may be a concern during the simultaneous power generation process in which charging and power generation are performed simultaneously.

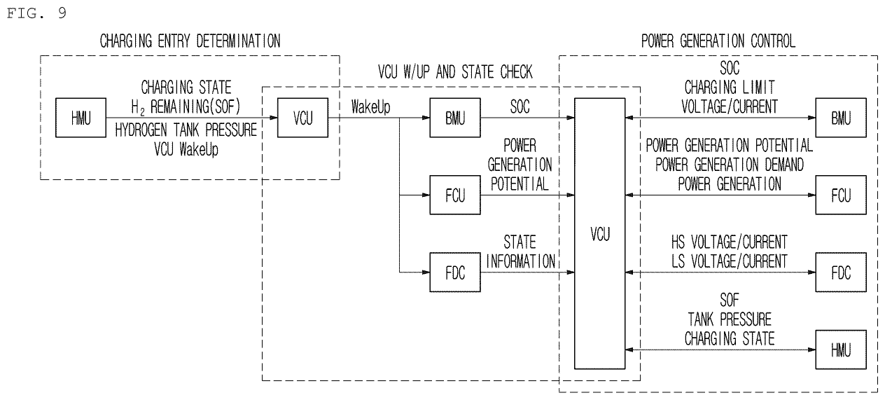

FIG. 9 shows an example of processing of a processing module during simultaneous charging according to the present disclosure.

Referring to FIG. 9, during simultaneous charging according to the example of the present disclosure, processing modules such as VCU, HMU, Battery management unit/system (BMU or BMS), FCU, and FDC may exchange information with each other for charging entry determination, VCU wake-up and state check, and power generation control. The VCU may be an upper processing module that manages the above-described processing modules. The HMU may be an individual processing module that performs management for supplying or blocking hydrogen to the fuel cell 104 (e.g., controlling hydrogen valves, pressure regulators, hydrogen pumps, or hydrogen recirculation pumps, etc.). The BMU may be an individual processing module that controls and manages the battery 102 (e.g., managing battery state-of-charge (SoC), voltage levels, current flow, battery cell balancing, or battery temperature, etc.). The FCU may be an individual processing module that performs management (e.g., stack operation control, hydrogen flow rate control, hydrogen injection, or fuel cell diagnostics, etc.) for supplying or blocking hydrogen to the fuel cell 104. The FDC may be an individual processing module that manages voltage or current (e.g., controlling DC-DC voltage conversion, current regulation, or power output conditioning, etc.) of power generated by the fuel cell 104.

The HMU may enter normal charging or simultaneous charging, or transmit, to the VCU, the charging state, the remaining fuel level in the fuel tank (e.g., State of Fuel (SoF)), the pressure of the fuel tank, and data or signals to wake up the VCU (e.g., wake-up signals triggered by hydrogen injection, tank pressure changes, or fuel supply initiation, etc.), for entry.

When the VCU wakes up, the VCU controls the BMU, the FCU, and the FDC to transmit information about the SoC of the battery 102, information about the power generation potential, power generation demand, and actual power generation of the fuel cell 104, and state information about power generated by the fuel cell 104. Specifically, the VCU may control the BMU to receive information about the SoC of the battery 102 (e.g., battery SoC percentage, remaining charging capacity, battery temperature, battery health state, cell voltage, or battery current, etc.). For example, information about the charge limit (e.g., maximum safe charge level, recommended battery SoC, or user-defined charge limit, etc.), current, and voltage of the battery 102 may be received. In addition, the VCU may control the FCU to receive information about the power generation potential (e.g., maximum fuel cell output, current stack capability, or available power generation margin, etc.), power generation demand (e.g., current load requirements, requested power level, or power required by connected modules, etc.), and actual power generation (e.g., measured stack voltage, generated current, or actual power output, etc.) of the fuel cell 104. In addition, the VCU may control the FDC to receive state information about power generated by the fuel cell 104 (e.g., high-side (HS) and low-side (LS) voltage/current readings, DC-DC converter state, or power stability metrics, etc.). The VCU may use the above-described information to examine state information for simultaneous charging of the mobility apparatus 100 and determine whether to enter normal charging or simultaneous charging. Additionally, the VCU may use the above-described information to determine whether to maintain simultaneous charging or re-enter normal charging (e.g., switching to normal charging due to battery overheating, insufficient fuel pressure, or user intervention, etc.). Additionally, the VCU may use the above-described information to decide whether to stop simultaneous charging and enter normal charging (e.g., battery fully charged, low fuel tank pressure, or exceeding operational thresholds, etc.).

In addition, the VCU exchanges information with individual processing modules to control the power generation of the fuel cell 104 when entering normal charging or simultaneous charging. Specifically, the VCU may exchange information (e.g., about the SoC, charging limit, current, voltage of the battery 102, battery diagnostic data, thermal management status, or charging safety conditions, etc.) with the BMU. The VCU may exchange information (e.g., about the power generation capacity, power generation demand, actual power generation of the fuel cell 104, stack health, operational efficiency, system errors, or fuel cell temperature conditions, etc.) with the FCU. The VCU may exchange state information of power generated by the fuel cell 104 with the FDC. For example, the VCU may exchange information about the high-side (HS) voltage/current (e.g., fuel cell stack high-voltage output, current delivery capability, or peak load current, etc.) and the low-side (LS) voltage/current (e.g., converted lower-voltage outputs, regulated current for low-power modules, or battery charging current, etc.) generated by the fuel cell 104 with the FDC. The VCU may exchange information about the remaining fuel amount in the fuel tank (e.g., SoF), the pressure of the fuel tank, or the fuel charging state (e.g., refueling progress, fueling rate, or fuel supply status, etc.), etc. with the HMU. The VCU may use the above-described information to control the power generation (e.g., adjusting fuel supply rates, regulating stack power output, balancing battery charging rates, or maintaining system safety limits, etc.) of the fuel cell 104 while simultaneously charging the battery 102.

According to one or more example examples of the present disclosure, a method performed by an apparatus may include: determining whether to enter normal charging or to examine state information for simultaneous charging based on driving conditions, entering the normal charging or requesting a response to a charging method based on whether the state information is normal and charging fuel by separating the mobility system and the charging system in response to a request to perform simultaneous charging, and simultaneously charging the battery depending on whether a pressure threshold is exceeded by incorporating a portion of the charging system into the mobility system.

The determining based on the driving conditions may comprise entering the normal charging when the driving conditions are satisfied and examining the state information for the simultaneous charging when at least one of the driving conditions is unsatisfied.

The driving conditions may comprise at least one of a target charge amount of the fuel, a minimum amount of fuel for the simultaneous charging, route setting information, or a type of fuel charging station.

The requesting the response to the charging method may comprise: entering the normal charging when at least one of the state information of components of the mobility apparatus required for the battery charging is abnormal and requesting the response to the charging method when the state information is normal.

The state information may comprise at least one of a pressure and temperature of the charging system, a stack state of a fuel cell, a power generation capacity of the fuel cell, a state of the battery or a relay state.

The simultaneously charging the battery may further comprise entering the normal charging when a simultaneous charging condition based on the state information and user state information is unsatisfied.

The pressure threshold may be differently set for each of a plurality of fuel tanks included in the charging system.

The simultaneously charging the battery may comprise: injecting the fuel into a first fuel tank of the charging system separated from the mobility system by a disconnected first connector, delivering the fuel to a second fuel tank using a second connector connecting the first fuel tank and the second fuel tank of the charging system when a pressure of the first fuel tank exceeds a first upper limit threshold and disconnecting the second connector and charging the battery using a third connector connecting the mobility system and the second fuel tank when a pressure of the second fuel tank exceeds a second upper limit threshold.

The method may further comprise, after the charging of the battery, disconnecting the third connector when a charge amount of the battery reaches a target charge amount or the pressure of the second fuel tank becomes lower than a second lower limit threshold in a state in which the simultaneous charging condition is satisfied.

The requesting the response to the charging method further comprises entering a default charging method set by a user in advance after a predetermined time.

According to one or more example examples of the present disclosure, the apparatus may comprise: a battery configured to supply power to the mobility apparatus, a power generation cell configured to charge the battery, a memory configured to store at least one instruction and a processor configured to execute the at least one instruction stored in the memory, wherein the processor may perform control to: determine whether to enter normal charging or to examine state information for simultaneous charging based on driving conditions, enter the normal charging or requesting a response to a charging method based on whether the state information is normal and charge fuel by separating the mobility system and the charging system in response to a request to perform simultaneous charging, and simultaneously charge the battery depending on whether a pressure threshold is exceeded by incorporating a portion of the charging system into the mobility system.

According to the present disclosure, it is possible to provide a method and mobility apparatus for simultaneous battery charging that charge a battery while charging fuel.

It will be appreciated by persons skilled in the art that that the effects that can be achieved through the present disclosure are not limited to what has been particularly described hereinabove and other advantages of the present disclosure will be more clearly understood from the detailed description.

While the methods of the present disclosure described above are represented as a series of operations for clarity of description, it is not intended to limit the order in which the steps are performed. The steps described above may be performed simultaneously or in different order as necessary. In order to implement the method according to the present disclosure, the described steps may further include different or other steps, may include remaining steps except for some of the steps, or may include other additional steps except for some of the steps.

The various examples of the present disclosure do not disclose a list of all possible combinations and are intended to describe representative examples of the present disclosure. Examples or features described in the various examples may be applied independently or in combination of two or more.

In addition, various examples of the present disclosure may be implemented in hardware, firmware, software, or a combination thereof. In the case of implementing the present disclosure by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various examples to be executed on an apparatus or a computer, a non-transitory computer-readable medium having such software or commands stored thereon and executable on the apparatus or the computer.

What is claimed:

1. A method performed by an apparatus of a vehicle, the method comprising:
determining, based on driving conditions of the vehicle, whether a state condition for a simultaneous charging operation is satisfied; and
based on the state condition for the simultaneous charging operation being satisfied, performing the simultaneous charging operation by controlling a fuel supply to a first fuel tank of the vehicle and a simultaneous charging of a battery of the vehicle, wherein at least a portion of fuel from a second fuel tank of the vehicle is used to generate power for the charging of the battery based on a pressure in the second fuel tank exceeding a pressure threshold, and wherein the first fuel tank is operatively decoupled from at least one component of the vehicle during the simultaneous charging operation.

2. The method of claim 1, further comprising determining, based on the driving conditions, whether to:
perform a fuel charging operation without simultaneous charging the battery when the driving conditions are satisfied; or
identify the state condition for the simultaneous charging operation when at least one of the driving conditions is unsatisfied.

3. The method of claim 1, wherein the driving conditions comprise at least one of:
a target charge amount of the fuel to be supplied to the first fuel tank,
a minimum amount of the at least the portion of the fuel from the second fuel tank for the simultaneous charging operation,
route setting information, or
a type of fuel charging station.

4. The method of claim 1, further comprising:
performing a fuel charging operation when the state condition for the simultaneous charging operation is not satisfied; and
requesting a response to select a charging method when the state condition for the simultaneous charging operation is satisfied.

5. The method of claim 4, wherein the state condition comprises at least one of:
a pressure and temperature of the first fuel tank and the second fuel tank,
a stack state of a fuel cell of the vehicle,
a power generation capacity of the fuel cell,
a state of the battery, or a state of a relay, wherein the relay corresponds to an electrical switch configured to control charging and discharging paths of the battery.

6. The method of claim 1, wherein the controlling of the simultaneous charging of the battery comprises:
based on a determination that at least one of the state condition or a user state condition is not satisfied, switching to a fuel charging operation and stopping charging the battery.

7. The method of claim 1, wherein a value of the pressure threshold is differently set for each of a plurality of fuel tanks comprising the first fuel tank and the second fuel tank.

8. The method of claim 1, wherein the controlling of the simultaneous charging of the battery comprises:
injecting fuel into the first fuel tank, wherein the first fuel tank is operatively decoupled from the at least one component of the vehicle by a changed state of a first connector, where the at least one component of the vehicle comprises a fuel supplier configured to supply fuel to a fuel cell of the vehicle;
delivering fuel to the second fuel tank using a second connector between the first fuel tank and the second fuel tank based on a pressure of the first fuel tank exceeding a first upper limit threshold; and
changing a state of the second connector to decouple the second fuel tank from the first fuel tank and charging the battery using a third connector between the fuel supplier and the second fuel tank based on the pressure of the second fuel tank exceeding the pressure threshold.

9. The method of claim 8, further comprising, after the charging of the battery, changing a state of the third connector to decouple the second fuel tank from the fuel supplier based on a charge amount of the battery reaching a target charge amount or the pressure of the second fuel tank no longer exceeding the pressure threshold.

10. The method of claim 1, further comprising:
requesting a response to select a charging operation; and based on a determination that the response has not been received within a predetermined time, selecting a default charging operation set by a user.

11. An apparatus of a vehicle, the apparatus comprising:
a battery configured to supply power to the vehicle;
a power generation cell configured to charge the battery;
a processor; and
a memory storing at least one instruction that, when executed by the processor communicating with the memory, is configured to cause the apparatus to:
determine, based on driving conditions of the vehicle, whether a state for a simultaneous charging operation is satisfied; and
based on the state condition for the simultaneous charging operation being satisfied, perform the simultaneous charging operation by controlling a fuel supply to a first fuel tank of the vehicle and a simultaneous charging of the battery,
wherein at least a portion of fuel from a second fuel tank of the vehicle is supplied to the power generation cell to charge the battery based on a pressure in the second fuel tank exceeding a pressure threshold, and wherein the first fuel tank is operatively decoupled from at least one component of the vehicle during the simultaneous charging operation.

12. The apparatus of claim 11, wherein the at least one instruction, when executed by the processor communicating with the memory, is configured to cause the apparatus to:
perform a fuel charging operation based on the driving conditions being satisfied; and
identify the state condition for the simultaneous charging operation based on at least one of the driving conditions is unsatisfied.

13. The apparatus of claim 11, wherein the driving conditions comprise at least one of:
a target charge amount of the fuel to be supplied to the first fuel tank,
a minimum amount of the at least the portion of the fuel from the second fuel tank for the simultaneous charging operation,
route setting information, or
a type of fuel charging station.

14. The apparatus of claim 11, wherein the at least one instruction, when executed by the processor communicating with the memory, is configured to cause the apparatus to:
perform a fuel charging operation based on the state condition for the simultaneous charging operation not being satisfied; and
request a response to select a charging method based on the state condition for the simultaneous charging operation being satisfied.

15. The apparatus of claim 14, wherein the state condition comprises at least one of:
a pressure and temperature of the first fuel tank and the second fuel tank,
a stack state of the power generation cell,
a power generation capacity of the power generation cell,
a state of the battery, or
a state of a relay, wherein the relay corresponds to an electrical switch configured to control charging and discharging paths of the battery.

16. The apparatus of claim 11, wherein the at least one instruction, when executed by the processor communicating with the memory, is configured to cause the apparatus to:
based on a determination that at least one of the state condition or a user state condition is not satisfied, switch from the simultaneous charging operation to a fuel charging operation and stop charging the battery.

17. The apparatus of claim 11, wherein a value of the pressure threshold is differently set for each of a plurality of fuel tanks comprising the first fuel tank and the second fuel tank.

18. The apparatus of claim 11, wherein the at least one instruction, when executed by the processor communicating with the memory, is configured to cause the apparatus to:
inject fuel into the first fuel tank, wherein the first fuel tank is operatively decoupled from the at least one component of the vehicle by a changed state of a first connector, wherein the at least one component of the vehicle comprises a fuel supplier configured to supply fuel to the power generation cell;
deliver fuel to the second fuel tank using a second connector between the first fuel tank and the second fuel tank based on a pressure of the first fuel tank exceeding a first upper limit threshold; and
change a state of the second connector to decouple the second fuel tank from the first fuel tank and charge the battery using a third connector between the fuel supplier and the second fuel tank based on the pressure of the second fuel tank exceeding the pressure threshold.

19. The apparatus of claim 18, wherein the at least one instruction, when executed by the processor communicating with the memory, is configured to cause the apparatus to change a state of the third connector to decouple the second fuel tank from the fuel supplier based on a charge amount of the battery reaching a target charge amount or the pressure of the second fuel tank no longer exceeding the pressure threshold.

20. A method performed by an apparatus of a vehicle, the method comprising:
supplying fuel to a first fuel tank of the vehicle while the first fuel tank is operatively decoupled from a fuel cell of the vehicle;
transferring at least a portion of the fuel from the first fuel tank to a second fuel tank of the vehicle based on a pressure of the first fuel tank exceeding a first pressure threshold;
operatively coupling the second fuel tank to the fuel cell based on a pressure of the second fuel tank exceeding a second pressure threshold; and
charging a battery of the vehicle using power generated by the fuel cell, wherein the fuel cell is supplied with at least a portion of fuel from the second fuel tank while fuel is being supplied to the first fuel tank.
